(19) United States
(12) Patent Application Publication
(10) Pub. No.: US 2017/0139502 A1
(43) Pub. Date: May 18, 2017

(54) TOUCH PANEL

(71) Applicant: PANASONIC INTELLECTUAL PROPERTY MANAGEMENT CO., LTD., Osaka (JP)

(72) Inventors: ITARU OOTANI, Osaka (JP); TSUTOMU AISAKA, Osaka (JP); MASAKAZU FUKUI, Osaka (JP)

(21) Appl. No.: 15/103,993

(22) PCT Filed: Feb. 6, 2015
(86) PCT No.: PCT/JP2015/000541

§ 371 Date: Jun. 13, 2016

(30) Foreign Application Priority Data
Feb. 10, 2014 (JP) 2014-022969
Sep. 26, 2014 (JP) 2014-197577

(51) Int. Cl. G06F 3/044

(52) U.S. Cl. CPC G06F 3/044; G06F 2203/04112; G06F 2203/04103

(57) ABSTRACT

A touch panel includes a first substrate, multiple first electrode parts, and multiple first dummy patterns. The first electrode parts are formed on the first substrate in the first direction. Each of the first dummy patterns are disposed between the first electrode parts. Multiple first grooves are formed surrounding the respective first dummy patterns.

### TECHNICAL FIELD

The present disclosure relates to a touch panel used mainly for operating a range of electronic devices.

### BACKGROUND ART

In recent years, electronic devices, such as mobile phones and electronic cameras, employ an input device for switching functions by touching a touch panel typically with a fingertip, while looking at a display screen disposed behind the touch panel. In the input device, a light transmissive electrostatic capacitive touch panel is mounted on the front face of the display screen, such as a liquid crystal display element.

FIG. 10 is a sectional view of conventional touch panel 100. FIG. 11 is an exploded perspective view of conventional touch panel 100. In the drawings, dimensions are partially magnified to facilitate understanding of the structure.

Light transmissive film-like first substrate 4 is formed of a film of resin, such as polyethylene terephthalate (hereinafter referred to as “PET”) or polycarbonate (hereinafter referred to as “PC”). A thickness of first substrate 4 is about 50 μm or more and 125 μm or less.

Light transmissive first electrode part 5 made typically of indium tin oxide (hereinafter referred to as “ITO”) is formed on the top face of first substrate 4. As shown in FIG. 11, multiple rectangular electrodes are connected in the X direction to form a strip of first electrode part 5. Multiple first electrode parts 5 are then aligned in the Y direction at regular intervals. In FIG. 11, first electrode parts 5 are hatched for easy recognition. Space 5A is formed between adjacent first electrode parts 5. Here, the X direction is a direction along one side of first substrate 4, and the Y direction is a direction intersecting with the X direction.

Multiple first wiring electrodes 6 formed typically of silver or carbon are disposed on one end of first substrate 4 in the X direction. Multiple electrodes led out from ends of first electrode parts 5 in the X direction are connected to respective first wiring electrodes 6.

Light transmissive film-like second substrate 1 is formed of a film of resin, such as PET or PC. A thickness of second substrate 1 is about 50 μm or more and 125 μm or less.

Light transmissive second electrode part 2 typically of ITO is formed on the top face of second substrate 1. As shown in FIG. 11, multiple rectangular electrodes are connected in the Y direction to form a strip of second electrode part 2. Multiple second electrode parts 2 are then aligned in the X direction at regular intervals. In FIG. 11, second electrode parts 2 are hatched for easy recognition. Space 2A is formed between adjacent second electrode parts 2.

Multiple second wiring electrodes 3 typically formed of silver or carbon are disposed at both ends of second substrate 1 in the Y direction. Multiple electrodes led out from both ends of second electrode parts in the Y direction are connected to respective second wiring electrodes 3.

Second substrate 1 is overlaid on first substrate 4, and cover substrate 7 is overlaid on second substrate 1. Touch panel 100 is configured by attaching each of these substrates with adhesive (not illustrated). Cover substrate 7 is typically configured with a light transmissive glass or resin sheet or a resin film.

Multiple second wiring electrodes 3 and first wiring electrodes 6 are electrically coupled to an electronic circuit (not illustrated) of equipment via a flexible wiring board and connector (not illustrated). Touch panel 100 is disposed on the front face of a display element (not illustrated), such as liquid crystal, and installed in an electronic device.

Voltage is applied from the electronic circuit to second wiring electrodes and then to first wiring electrodes 6. When an operator operates the top face of cover substrate 7 with a fingertip according to a display on the display element disposed on the rear face of touch panel 100, electrostatic capacitance between second electrode part 2 and first electrode part 6 where operated changes. The electronic circuit detects this change of electrostatic capacitance to identify a part operated. In this way, the device is switched to various functions.

More specifically, for example, when the operator touches with a fingertip a part of the top face of cover substrate 7 corresponding to a desired menu in the state multiple menus are displayed on the display element, a part of electric charge is electrically conducted to the finger, and electrostatic capacitance between second electrode part 2 and first electrode part 5 at a part operated changes. The electronic circuit detects this change to enable the operator to select the desired menu.

Known prior arts related to the disclosure are, for example, PTL1 and PTL2.

### CITATION LIST

### Patent literature

PTL1 Japanese Patent Unexamined Publication No. 2013-089181

PTL2 Japanese Patent Unexamined Publication No. 2013-054554

### SUMMARY OF THE INVENTION

A touch panel includes a first substrate, multiple first electrode parts, and multiple first dummy patterns. The first electrode parts are formed on the first substrate in a first direction. Each of the first dummy patterns is disposed between the first electrode parts. Multiple first grooves are formed surrounding the respective first dummy patterns.

### BRIEF DESCRIPTION OF DRAWINGS

FIG. 1 is a sectional view of a touch panel in accordance with an exemplary embodiment.

FIG. 2 is an exploded perspective view of the touch panel in accordance with the exemplary embodiment.

FIG. 3 is a schematic plan view of a first electrode part and a dummy pattern of the touch panel in accordance with the exemplary embodiment.

FIG. 4 is a schematic plan view of the first electrode part and the dummy pattern of another touch panel in accordance with the exemplary embodiment.

FIG. 5 is a schematic plan view of the first electrode part and the dummy pattern of still another touch panel in accordance with the exemplary embodiment.

FIG. 6 is a schematic plan view of the first electrode part and the dummy pattern of still another touch panel in accordance with the exemplary embodiment.

FIG. 7 is a schematic plan view of the first electrode part and the dummy pattern of still another touch panel in accordance with the exemplary embodiment.

FIG. 8 is a sectional view of still another touch panel in accordance with the exemplary embodiment.

FIG. 9 is a sectional view of still another touch panel in accordance with the exemplary embodiment.

FIG. 10 is a sectional view of a conventional touch panel.

FIG. 11 is an exploded perspective view of the conventional touch panel.

FIG. 12 is a schematic sectional view of a first substrate and a first electrode part of the conventional touch panel.

### DESCRIPTION OF EMBODIMENTS

As a range of electronic devices are becoming thinner, a demand for thinner touch panels installed in these devices is also increasing.

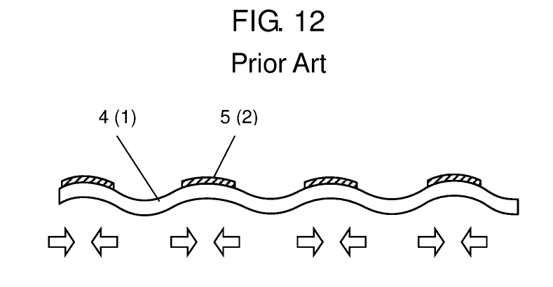

FIG. 12 is a schematic sectional view of first substrate 4 and first electrode part 5 of conventional touch panel 100. For example, when a PET resin film of about 50-μm thick is used for first substrate 4 to make the touch panel thinner, an internal stress is concentrated on first substrate 4 at a part where first electrode part 5 is formed, as shown by arrows. As a result, first substrate 4 is undulated and becomes wavy. This may degrade the appearance quality. The same phenomenon occurs with second substrate 1 where second electrode part is formed.

### Exemplary Embodiment

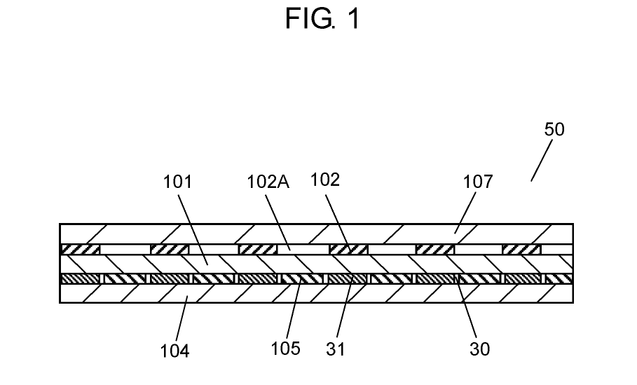

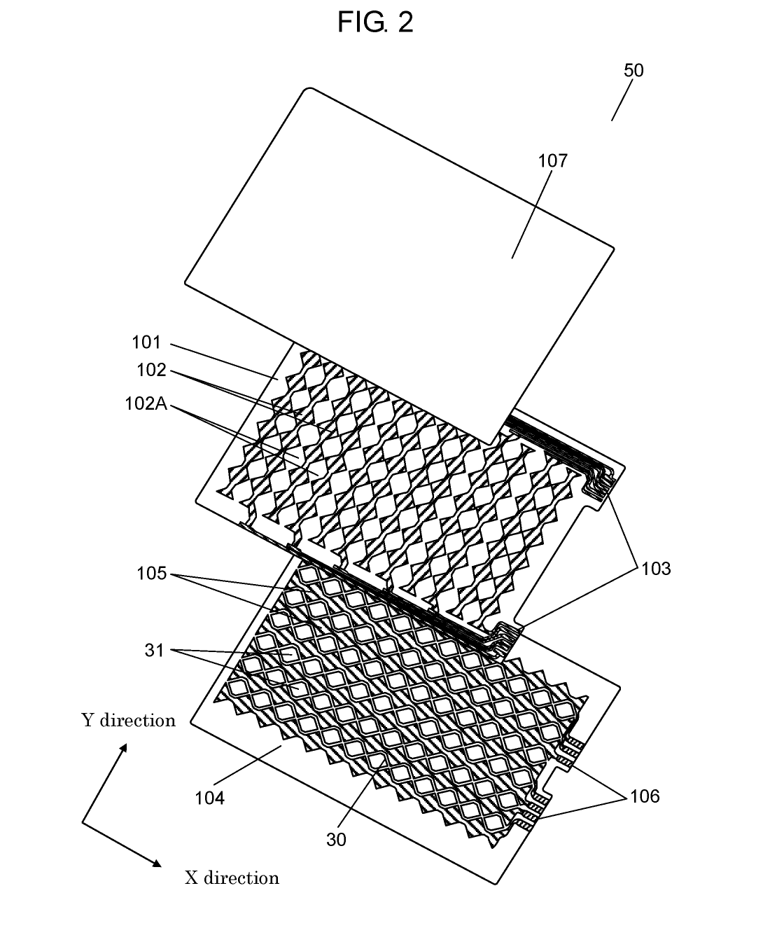

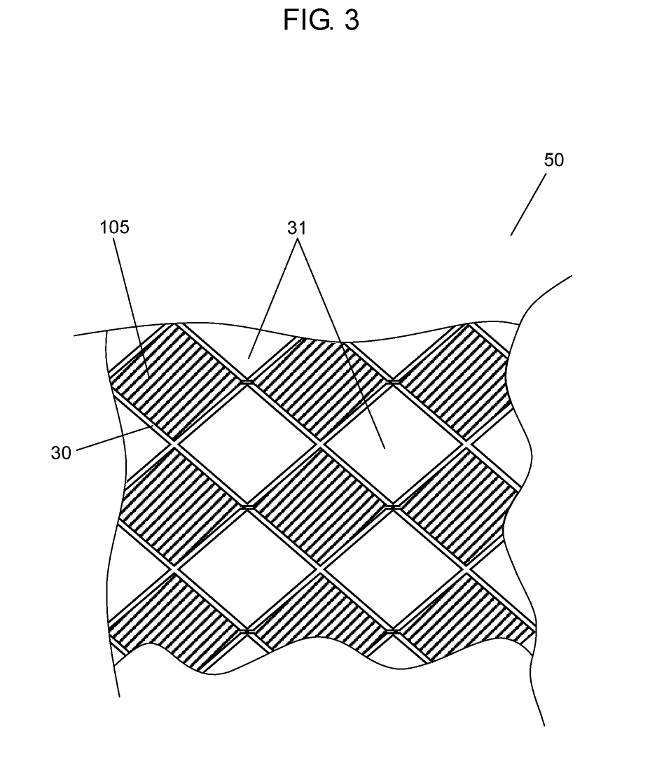

FIG. 1 is a sectional view of touch panel 50 in the exemplary embodiment. FIG. 2 is an exploded perspective view of touch panel 50 in the exemplary embodiment. FIG. 3 is a schematic plan view of first electrode part 105 and dummy pattern 31 of touch panel 50 in the exemplary embodiment.

Touch panel 50 includes first substrate 104, multiple first electrode parts 105, and multiple dummy patterns 31 (first dummy patterns). First electrode parts 105 are formed on first substrate 104 in the X direction (first direction). Each of dummy patterns 31 is provided between first electrode parts 105. Multiple grooves 30 (first grooves) are formed surrounding respective dummy patterns 31.

A point that touch panel 50 in the exemplary embodiment differs from conventional touch panel 100 is the formation of dummy patterns 31 and grooves 30.

Light transmissive film-like first substrate 104 is formed typically of a polyethylene terephthalate (PET) or polycarbonate (PC) resin film. A thickness of first substrate 104 is about 50 μm or more and 125 μm or less.

Light transmissive first electrode part 105 typically of indium tin oxide (ITO) is formed on the top face of first substrate 104. As shown in FIG. 2, multiple rectangular electrodes are connected in the X direction (first direction) to form a strip of first electrode part 105. Multiple first electrode parts 105 are then aligned in the Y direction (second direction) at regular intervals. In FIGS. 2 to 4, first electrode parts 105 are hatched for easy recognition. Here, the X direction is a direction along one side of substrate 104, and the Y direction is a direction intersecting with the X direction.

Multiple first wiring electrodes 106 formed typically of silver or carbon are disposed at one end of first substrate 104 in the X direction. Multiple electrodes led out from an end of first electrode parts 105 in the X direction are connected to respective first wiring electrodes 106.

Light transmissive film-like second substrate 101 is typically formed of a PET or PC resin film. The thickness of second substrate 101 is about 50 μm or more and 125 μm or less.

Light transmissive second electrode part 102 typically of ITO is formed on the top face of second substrate 101. As shown in FIG. 2, multiple rectangular electrodes are connected in the Y direction to form a strip of second electrode part 102. Multiple second electrode parts 102 are then aligned in the X direction at regular intervals. Space 102A is formed between adjacent second electrode parts 102.

Multiple second wiring electrodes 103 formed typically of silver or carbon are disposed at both ends of second substrate 101 in the Y direction. The electrodes led out from both ends of second electrode parts 102 in the Y direction are connected to respective second wiring electrodes 103.

Second substrate 101 is overlaid on first substrate 104, and cover substrate 107 is overlaid on second substrate 101. Each of these substrates is attached with adhesive (not illustrated) to configure touch panel 50. Cover substrate 107 is typically configured with a light transmissive glass or resin sheet or resin film.

Multiple second wiring electrodes 103 and first wiring electrodes 106 are electrically coupled to an electronic circuit (not illustrated) of a device typically via a flexible wiring board and connector (not illustrated). Touch panel 50 is disposed on the front face of a display element (not illustrated), such as liquid crystal, and installed in the electronic device.

Voltage is applied from the electronic circuit to second wiring electrodes 103 and then to first wiring electrodes 106. When an operator operates the top face of cover substrate 107 typically with a fingertip, according to a display of the display element disposed on the rear face of touch panel 50, electrostatic capacitance between second electrode part 102 and first electrode part 105 changes at a part operated. The electronic circuit detects this change of electrostatic capacitance to identify the operated part. In this way, the device can be switched to various functions.

More specifically, for example, when the operator touches with a fingertip a part of the top face of cover substrate 107 corresponding to a desired menu in a state multiple menus are displayed on the display element, a part of electric charge is electrically conducted to the finger, and thus electrostatic capacitance between second electrode part 102 and first electrode part 105 changes at the part operated. A desired menu can be selected by detecting this change by the electronic circuit.

As shown in FIG. 3, dummy pattern 31 is formed between first electrode parts 105. Groove 30 (first groove) is formed between first electrode part 105 and dummy pattern 31. In other words, first electrode part 105 is surrounded by dummy pattern 31 via groove 30. Dummy pattern 31 is provided on first substrate 104 in an area where first electrode part 105 is not formed. The surface of dummy pattern 31 is flat.

Dummy pattern 31 is formed with the same material as first electrode part 105. A width of groove 30 between an outer rim of first electrode part 105 and an outer rim of dummy pattern 31 is 10 μm or more and 100 μm or less.

More specifically, dummy pattern 31 is formed with the same material as first electrode part 105 on first substrate 104 in an area where first electrode part 10 is not formed. This structure achieves the same state as an area where first electrode part 105 is formed in the area first electrode part 105 is not formed. As a result, the concentration of internal stress on the area where first electrode part 105 is formed is decreased to reduce occurrence of undulation of first substrate 104.

The thinner the resin sheet used as first substrate 104 is, the greater the concentration of internal stress on the area where first electrode part 105 exists. Then, a possibility of causing the waved state due to undulation of first substrate 104 increases. For example, when PET resin with a thickness of 150 μm or less is used as first substrate 104, obvious waving phenomenon occurs. In this case, the waving phenomenon can be suppressed by forming dummy pattern 31. Young's modulus of PET resin is not less than 1000 MPa and not greater than 5,400 MPa.

PC resin has smaller Young's modulus than PET resin, and is not less than 1000 MPa and not greater than 5,000 MPa. Therefore, the use of PC resin is more likely to cause undulation. For example, when PC resin with a thickness of not greater than 200 μm is used as first substrate 104, obvious waving phenomenon occurs. Also in this case, the waving phenomenon can be suppressed by forming dummy pattern 31.

In addition to PET resin and PC resin, the exemplary embodiment is also effective when other resins, such as cycloolefin copolymer (COC) and cycloolefin polymer (COP), are used.

A dimension of groove 30 between the outer rim of first electrode part 105 and the outer rim of dummy pattern 31 is designed with consideration to characteristics and thickness of first substrate 104 and a formation method of dummy pattern 31. when groove 30 is too wide, an effect of reducing the concentration of internal stress decreases. The width of groove 30 is thus not greater than 100 μm, and preferably, not greater than several tens of μm. In addition, since thinner first substrate 104 is more likely to cause the waving state, the width of groove 30 is preferably not greater than the thickness of first substrate 104.

When first electrode part 105 and dummy pattern 31 are formed by etching ITO, etching workability is preferably considered. For example, when PET resin with a thickness not greater than 25 μm and not less than 150 μm is used as first substrate 104, groove 30 with a width not less than 10 μm is preferably formed. In other words, the width of groove 30 is preferably not less than 10 μm and not greater than 100 μm.

Moreover, when PC resin with a thickness of not less than 50 μm and not greater than 200 μm is used as first substrate 104, the width of groove 30 is preferably not less than 10 μm and not greater than 80 μm.

Dummy pattern 31 may be formed of a material different from that of first electrode part 105. However, the use of same material for dummy pattern 31 and first electrode part 105 is preferable because first electrode part 105 and dummy pattern 31 can be formed in the same production process.

Still more, dummy pattern 31 may have a thickness different from that of first electrode part 105. However, the same thickness for dummy pattern 31 and first electrode part 105 improves visibility of the touch panel. In other words, the formation of dummy pattern 31 reduces the occurrence of undulation of first substrate 104, and also improves visibility.

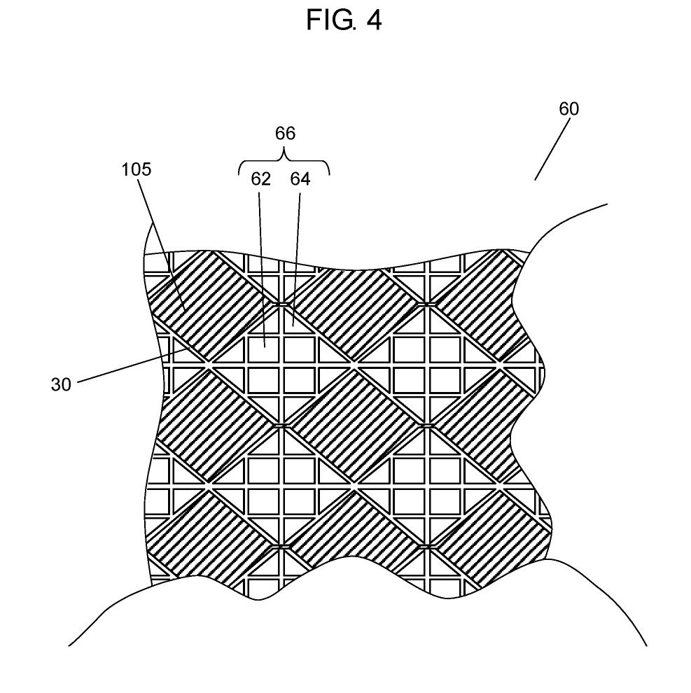

FIG. 4 is a schematic plan view of first electrode part 105 and dummy pattern 66 of another touch panel 60 in the exemplary embodiment. In FIG. 3, single independent rectangular dummy pattern 31 is disposed between adjacent first electrode parts 105. However, as shown in FIG. 4, dummy pattern 66 may be formed with multiple first structural patterns 62 and multiple second structural patterns 64. The structural pattern may not be two types. In other words, dummy pattern 66 is acceptable as long as it includes at least two types of structural patterns.

More specifically, dummy pattern 66 includes first structural patterns 62 and second structural patters 64 in an area where first electrode part 105 is not formed. First structural patterns 62, second structural patterns 64, and first electrode parts are divided by respective grooves 30. In other words, first structural patterns 62, second structural patterns 64, and first electrode parts 105 are disposed independently. In the exemplary embodiment, first structural pattern 62 is quadrilateral, which is a similar shape to each electrode of first electrode part 105. Second structural pattern 64 is triangle adjacent to the outer rim of first electrode part 105.

A width dimension of groove 30 between the outer rim of first electrode part 105 and the outer rim of dummy pattern 66 is same as that of aforementioned dummy pattern 31. A distance between first structural patterns 62, between second structural patterns 64, and between first structural pattern 62 and second structural pattern 64 is also almost the same dimension.

In touch panel 60, a portion of dummy pattern 66 without first structural pattern 62 or second structural pattern 64 is subdivided and uniformly disposed on first substrate 104. Therefore, undulation of first substrate 104 in an area first electrode part 105 is formed can be suppressed. Shapes of first structural pattern 62 and second structural pattern 64 may be polygons other that the above shapes, circular, oval, and so on.

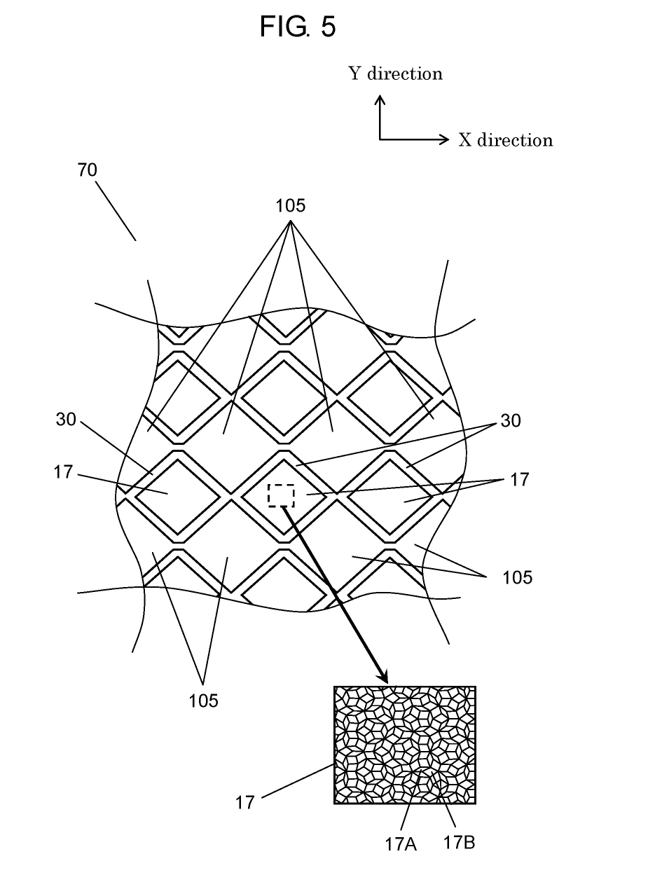

FIG. 5 is a schematic plan view of first electrode part 105 and dummy pattern 17 of still another touch panel 70 in the exemplary embodiment. Dummy pattern 17 is configured with first structural pattern 17A and second structural pattern 17B, as shown in a magnified view in a frame led out in FIG. 5. Dummy pattern 17 is aperiodic filling with rotational periodicity (rotational symmetry) and without translational periodicity. More specifically, first structural pattern 17A and second structural pattern 17B have rotational periodicity but no translational periodicity to fill the plane aperiodically. First structural pattern 17A and second structural pattern 17B are independently disposed adjacent to each other. In other words, a groove is formed between first structural pattern 17A and second structural pattern 17B. ITO is not formed in the groove.

Dummy pattern 17 is a five-fold rotational symmetry. First structural pattern 17A is a rhombus whose interior angles are π/5 and 4π/5. Second structural pattern 17B is a rhombus whose interior angles are 2π/5 and 3π/5. Here, π is 180°. The sides of first structural pattern 17A and second structural pattern 17B have the same length.

An equal slight space is provided between first structural pattern 17A and second structural pattern 17B to dispose them independently. Furthermore, first structural pattern 17A and second structural pattern 17B are disposed such that dummy pattern 17 becomes an aperiodic filling pattern with rotational periodicity and without translational periodicity. Dummy pattern 17 may be a so-called Penrose tiling pattern.

To design dummy pattern 17 that achieves the above structure, just the interior angles and size of a rhombus of each of first structural pattern 17A and second structural pattern 17B are decided to fill these rhombuses aperiodically. Accordingly, dummy pattern 17 can be easily designed. As a result, a time spent for pattern designing can be reduced, compared to aligning polygon shapes at random without any space in between them. Still more, since this structure is a geometric pattern, spaces between rhombuses also create a geometric pattern. This suppresses variations in space dimensions.

As described above, an outer shape of dummy pattern 17 is rectangular but it consists of first structural pattern 17A and second structural pattern 17B of predetermined rhombuses (polygons). They are disposed to create the aperiodic filling pattern with rotational periodicity and without translational periodicity. First structural pattern 17A and second structural pattern 17B are preferably made of the same material as first electrode part 15.

Since dummy pattern 17 has almost no linear periodicity, unrequired linear shade is inconspicuous. This achieves touch panel 70 with good visibility.

The above example describes dummy pattern 17 in a five-fold rotational symmetry. However, as long as dummy pattern 17 has n-fold rotational symmetry (n is a positive number), it is not limited to the five-fold rotational symmetry.

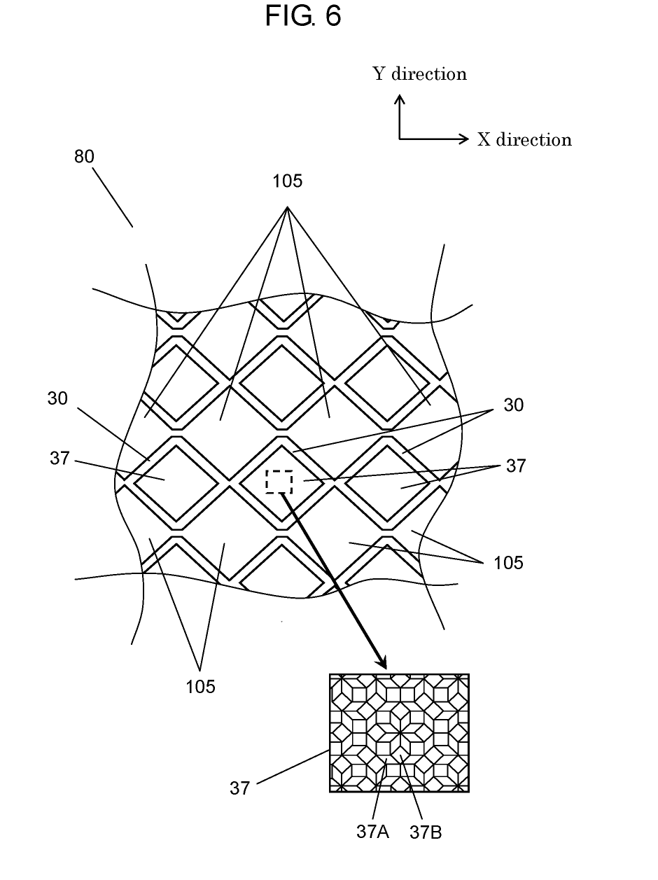

FIG. 6 is a schematic plan view of first electrode part 105 and dummy pattern 37 of still another touch panel 80 in the exemplary embodiment. Touch panel 80 has dummy pattern 37 different from dummy pattern 17.

As shown in a magnified view in a frame led out in FIG. 6, dummy pattern 37 includes rhombic first structural pattern 37A and square second structural pattern 37B. Dummy pattern 37 is an aperiodic filling pattern with rotational periodicity and without translational periodicity. First structural pattern 37A and second structural pattern 37B are disposed adjacent to each other but they are independent.

Dummy pattern 37 has an eight-fold rotational symmetry. First structural pattern 37A is a rhombus whose interior angles are π/4 and 3π/4. Second structural pattern 37B is a square whose interior angle is π/2. Here, π is 180°. The sides of first structural pattern 37A and second structural pattern 37B have the same length.

First structural pattern 37A and second structural pattern 37B are disposed with an equal slight space in between them. In addition, first structural pattern 37A and second structural pattern 37B are disposed such that dummy pattern 37 becomes the aperiodic filling pattern with rotational periodicity and without translational periodicity. First structural pattern 37A and second structural pattern 37B are preferably made of the same material as first electrode part 105.

By the use of above dummy pattern 37, designing becomes easy, and also touch panel 80 with good visibility can be achieved.

A dummy pattern with an n-fold rotational symmetry other than the above may also be used. For example, a seven-fold rotational symmetric figure, i.e., n=7, is formed by three types of rhombic structural patterns. More specifically, a rhombus whose interior angles are π/7 and 6π/7, a rhombus whose interior angles are 2π/7 and 5π/7, and a rhombus whose interior angles are 3π/7 and 4π/7 are used. The sides of these rhombuses have the same length. These three types of rhombuses are disposed in the aperiodic filling pattern without rotational periodicity and without translational periodicity.

A nine-fold rotational symmetric figure, i.e., n=9, is formed by four types of rhombic structural patterns. More specifically, a rhombus whose interior angles are π/9 and 8π/9, a rhombus whose interior angles are 2π/9 and 7π/9, a rhombus whose interior angles are 3π/9 and 6π/9, and a rhombus whose interior angles are 4π/9 and 5π/9 are used. The sides of these rhombuses have the same length. These four types of rhombuses are disposed in the aperiodic filling pattern with rotational periodicity and without translational periodicity.

A ten-fold rotational symmetric figure, i.e., n=10, is formed by two types of rhombic structural patterns. More specifically, a rhombus whose interior angles are π/5 and 4π/5 and a rhombus whose interior angles are 2π/5 and 3π/5 are used. The sides of these rhombuses have the same length. These two types of rhombuses are disposed in the aperiodic filling pattern with rotational periodicity and without translational periodicity.

An eleven-fold rotational symmetric figure, i.e., n=11, is formed by five types of rhombic structural patterns. More specifically, a rhombus whose interior angles are π/11 and 10π/11, a rhombus whose interior angles are 2π/11 and 9π/11, a rhombus whose interior angles are 3π/11 and 8π/11, a rhombus whose interior angles are 4π/11 and 7π/11, and a rhombus whose interior angles are 5π/11 and 6π/11 are used. The sides of these rhombuses have the same length. These five types of rhombuses are disposed in the aperiodic filling pattern with rotational periodicity and without translational periodicity.

A twelve-fold rotational symmetric figure, i.e., n=12, is formed by three types of rhombic structural patterns. More specifically, a rhombus whose interior angles are π/6 and 5π/6, a rhombus whose interior angles are π/3 and 2π/3, and a rhombus whose interior angles are π/2 and π/2 are used. The sides of these rhombuses have the same length. These three types of rhombuses are disposed in the aperiodic filling pattern with rotational periodicity and without translational periodicity.

A dummy pattern may have a structure other than the above. However, a dummy pattern is preferably the aperiodic filling pattern with rotational periodicity and without translational periodicity. Still more a structural pattern is not limited to polygonal outer shape. The number of structural patterns to be used is also not limited. However, a structural pattern with polygonal outer shape facilitates designing. In the above, multiple independent dummy patterns are independently disposed between adjacent first electrode parts 105. These multiple dummy patterns may be connected to generate an integral dummy pattern and this dummy pattern may be disposed between adjacent first electrode parts 105.

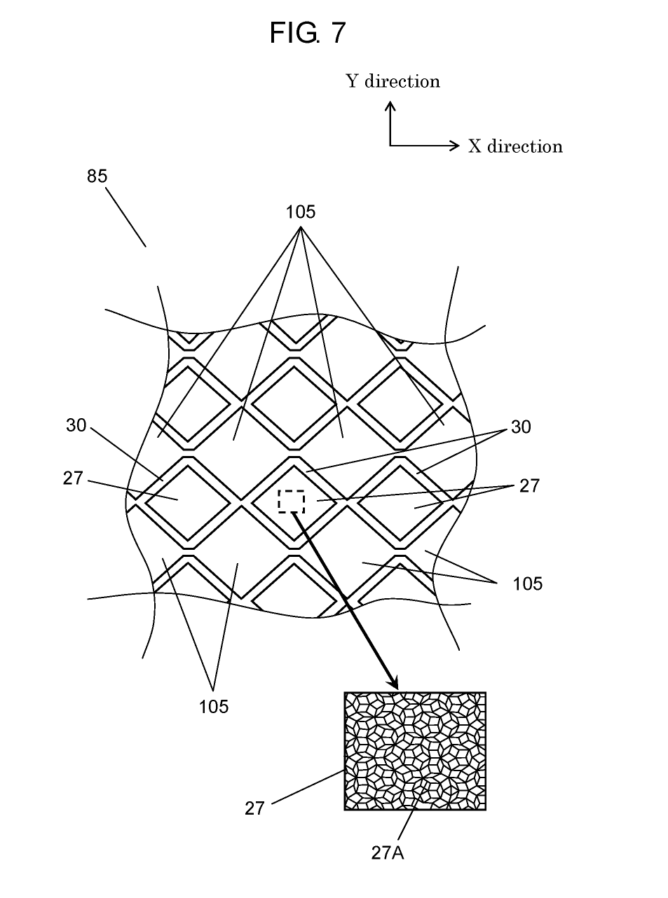

A structural pattern may be further modified. For example, the above structural pattern and space may be reversed. FIG. 7 is a schematic plan view of first electrode part 105 and dummy pattern 27 of still another touch panel 85 in the exemplary embodiment. Touch panel 85 is formed using dummy pattern 27 different from dummy pattern 17 and dummy pattern 37. In dummy pattern 27, structural pattern 27A is a mesh pattern, as shown in a magnified view in a frame led out in FIG. 7. In other words, a mesh structural pattern may be used. An area without ITO surrounded by structural pattern 27A has rotational periodicity but no translational periodicity. This structure is also easy to design. The mesh structural pattern can improve interference stripes. In addition to the dummy pattern, the mesh structural pattern may be used as first electrode part 105. In this case, interference stripes can be further improved. A material of the structural pattern is not limited to ITO. Also in the above case, multiple independent dummy patterns are disposed between adjacent first electrode parts 105. These multiple dummy patterns may be connected to generate an integral dummy pattern and this dummy pattern may be disposed between adjacent first electrode parts 105.

The above description refers to a touch panel having two layers: first substrate 104 and second substrate 101. However, a touch panel may have a single layer. Undulation is more likely to occur in two-layer touch panels. Therefore, an effect of suppressing undulation by providing a dummy pattern is more apparent in touch panels employing a two-layer substrate.

As described above, in the touch panel in the exemplary embodiment, the dummy pattern is formed in an area where first electrode part 105 is not formed. Groove 30 is formed between first electrode part 105 and the dummy pattern. This achieves a high-quality electrostatic capacitance touch panel with suppressed undulation of first substrate 104. When a material of first substrate 104 is a resin sheet made of PC resin, a high-quality touch panel also with good optical characteristics can be achieved.

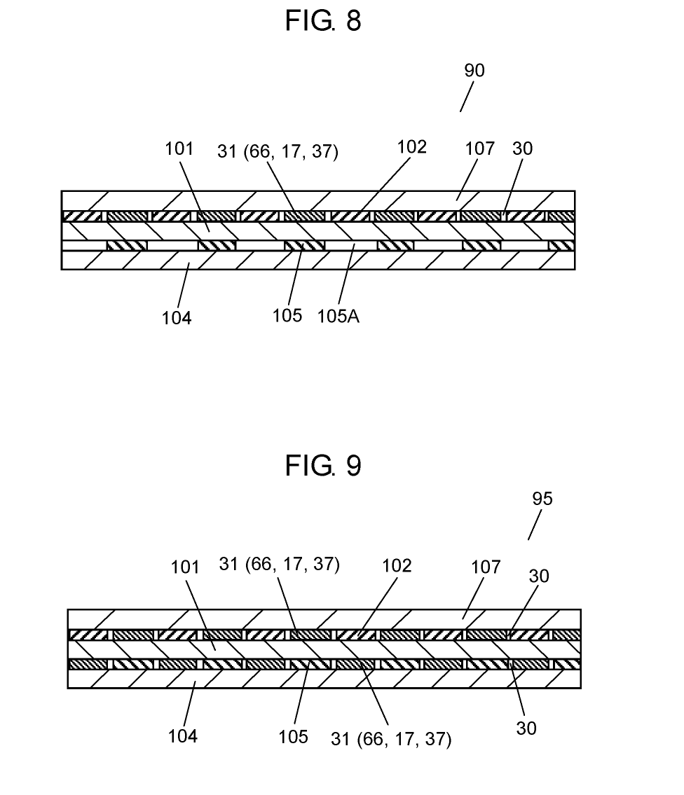

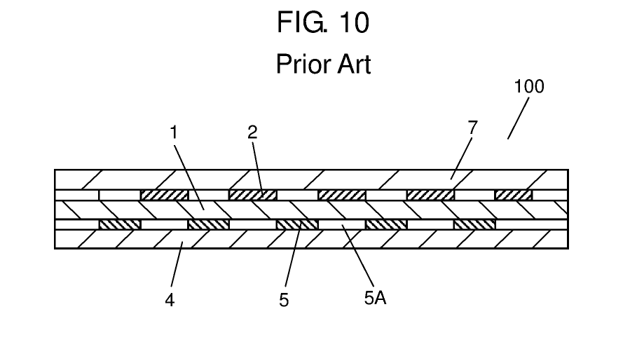

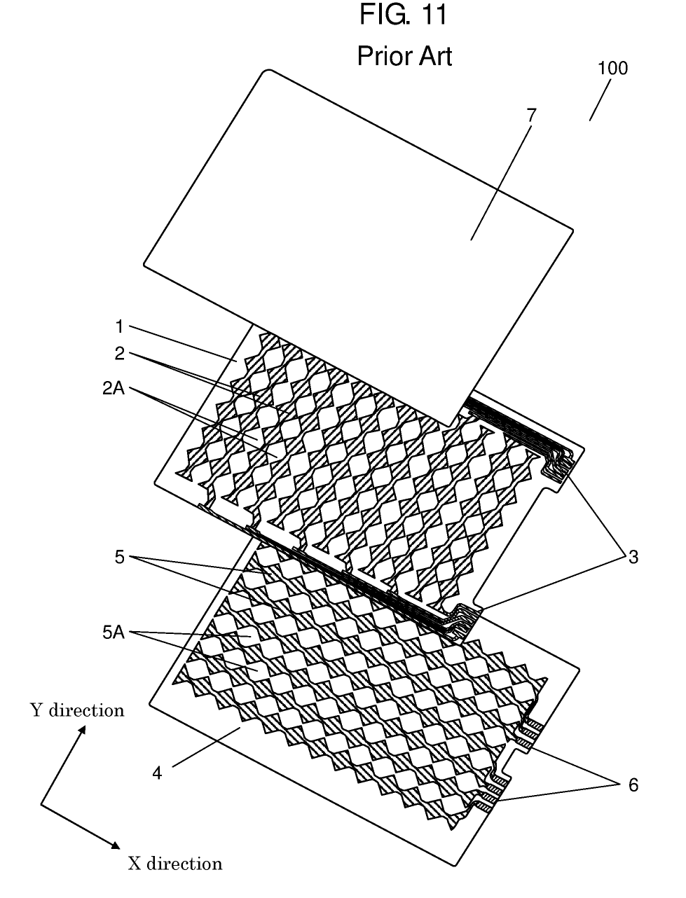

FIG. 8 is a sectional view of still another touch panel 90 in the exemplary embodiment. FIG. 9 is a sectional view of still another touch panel 95 in the exemplary embodiment. In touch panel 50, dummy pattern 31 and groove 30 (first groove) are formed on first substrate 104. However, as shown in FIG. 8, dummy pattern 31 (second dummy pattern) and groove 30 (second groove) may be formed on second substrate 101. In this case, space 105A is provided between adjacent first electrode parts 105. Still more, as shown in FIG. 9, dummy pattern 31 and groove 30 may be formed on both first substrate 104 and second substrate 101. Furthermore, dummy pattern 66, 17, or 37 may be used instead of dummy pattern 31 in FIG. 8 and FIG. 9.

When a dummy pattern and groove are formed on both first substrate 104 and second substrate 101, dummy patterns on first substrate 104 and second substrate 101 do not need to be the same shape. They may have similar shapes.

The above exemplary embodiment enables to reduce the concentration of internal stress on the substrate, and suppress undulation of substrate in an area where the electrode part is formed.

### INDUSTRIAL APPLICABILITY

The touch panel of the present disclosure is effectively applicable mainly to operating parts of a range of electronic devices.

### REFERENCE MARKS IN THE DRAWINGS

1, 101 Second substrate

2, 102 Second electrode part

2A, 102A Space

3, 103 Second wiring electrode

4, 104 First substrate

5, 105 First electrode part

5A, 105A Space

6, 106 First wiring electrode

7, 107 Cover substrate

17A, 37A, 62 First structural pattern

17B, 37B, 64 Second structural pattern

27A Structural pattern

30 Groove

31, 66, 17, 27, 37 Dummy pattern

50, 60, 70, 80, 85, 90, 95, 100 Touch panel

1. A touch panel comprising:
a first substrate;
a plurality of first electrode parts formed on the first substrate in a first direction; and
a plurality of first dummy patterns, each of which being disposed between the plurality of first electrode parts,
wherein a plurality of first grooves are formed surrounding the plurality of respective first dummy patterns.

2. The touch panel of claim 1, wherein a surface of each of the plurality of first dummy patterns is flat.

3. The touch panel of claim 1, wherein each of the plurality of first dummy patterns includes a plurality of structural patterns.

4. The touch panel of claim 3, wherein the plurality of structural patterns include a quadrilateral structural pattern and a triangular structural pattern.

5. The touch panel of claim 3, wherein the plurality of structural patterns are rhombic structural patterns.

6. The touch panel of claim 3, wherein the plurality of structural patterns include a rhombic structural pattern and a square structural pattern.

7. The touch panel of claim 3, wherein the plurality of structural patterns have a rotational periodicity but no translational periodicity.

8. The touch panel of claim 7, wherein the plurality of structural patterns are aperiodic filling patterns.

9. The touch panel of claim 3, wherein the plurality of structural patterns are disposed in a mesh state.

10. The touch panel of claim 9, wherein an area surrounded by the plurality of structural patterns has a rotational periodicity but no translational periodicity.

11. The touch panel of claim 3, wherein the plurality of structural patterns are Penrose tiling patterns.

12. The touch panel of claim 1, wherein a width of the grooves is not less than 10 μm and not greater than 100 μm.

13. The touch panel of claim 1, wherein the first dummy patterns are formed of a material same as the first electrode parts.

14. The touch panel of claim 1, wherein Young's modulus of the first substrate is not less than 1000 MPa and not greater than 5400 MPa.

15. The touch panel of claim 1, further comprising:
a second substrate;
a plurality of second electrode parts formed on the second substrate in a second direction; and
a plurality of second dummy patterns, each of which being disposed between the plurality of second electrode parts,
wherein a plurality of second grooves are formed surrounding the plurality of respective second dummy patterns, and
the first substrate and the second substrate are disposed such that the plurality of first electrode parts face a surface opposite to a surface where the plurality of second electrode parts are formed on the second substrate.
